(19) United States
(12) Patent Application Publication
(10) Pub. No.: US 2021/0278813 A1
(43) Pub. Date: Sep. 9, 2021

(54) DEVICE CONTROL APPARATUS, DEVICE APPARATUS, CONTROL METHOD, PROGRAM, AND DEVICE CONTROL SYSTEM

(71) Applicant: SONY CORPORATION, TOKYO (JP)

(72) Inventor: YUYA ISHIKAWA, TOKYO (JP)

(21) Appl. No.: 16/330,901

(22) PCT Filed: Oct. 20, 2017
(86) PCT No.: PCT/JP2017/037970

§ 371 Date: Mar. 6, 2019

(30) Foreign Application Priority Data
Nov. 4, 2016 (JP) 2016-215947

(51) Int. Cl. G05B 19/042

(52) U.S. Cl. CPC G05B 19/042; G05B 2219/23113

(57) ABSTRACT

The present technique relates to a device control apparatus, a device apparatus, a control method, a program, and a device control system that allow execution of a process needing a processing time longer than a processing time permitted for one command. A transmission unit of host equipment transmits, to the device apparatus, a first command for causing a prescribed process to be divided and executed. A reception unit of the host equipment acquires, from the device apparatus, a remaining number of times needed before completion of the prescribed process, after a division process of the device apparatus based on the first command is completed. The transmission unit of the host equipment repeatedly executes transmission of the first command the remaining number of times. The present technique is applicable to, for example, a digital camera controlling a memory card.

### TECHNICAL FIELD

The present technique relates to a device control apparatus, a device apparatus, a control method, a program, and a device control system, and in particular, to a device control apparatus, a device apparatus, a control method, a program, and a device control system that allow execution of a process needing a processing time longer than a processing time permitted for one command.

### BACKGROUND ART

In a case where a device apparatus executes a process needing a long time under the control of host equipment, the device apparatus transitions to, for example, a state where the device apparatus is precluded from receiving a new command from the host equipment until the process is completed or a state where the device apparatus is allowed to receive only limited commands such as a command for checking a progress of the process. Examples of such a process needing a long time include, for example, a global initialization process (formatting process) processed on a memory card (see, for example, PTL 1).

### CITATION LIST

### Patent Literature

[PTL 1]

Japanese Patent Laid-Open No. 2003-308241

### SUMMARY

### Technical Problem

However, for example, some communication protocols specify a prescribed time as the processing time provided when one command is received, and provide no state transition as described above. Even such a system is required to be capable of executing a process needing a processing time longer than the processing time permitted for one command.

In view of such a situation, an object of the present technique is to allow execution of a process needing a processing time longer than the processing time permitted for one command.

### Solution to Problem

A device control apparatus according to a first aspect of the present technique includes a transmission unit transmitting, to a device apparatus, a first command for causing a prescribed process to be divided and executed in a case where the device apparatus is caused to execute the prescribed process, and an acquisition unit acquiring, from the device apparatus, a remaining number of times needed before completion of the prescribed process, after a division process of the device apparatus based on the first command is completed. The transmission unit repeatedly executes transmission of the first command the remaining number of times.

A control method according to the first aspect of the present technique includes a transmission unit of a device control apparatus for causing a device apparatus to transmit a first command, the device control apparatus controlling operation of the device apparatus, the first command causing a prescribed process to be divided and executed, and an acquisition unit of the device control apparatus acquiring, from the device apparatus, a remaining number of times needed before completion of the prescribed process, after a division process of the device apparatus based on the first command is completed. The transmission unit repeatedly executes transmission of the first command the remaining number of times.

A program according to the first aspect of the present technique causes a computer to function as a transmission unit and an acquisition unit, the transmission unit causing a first command to be transmitted to a device apparatus, the first command causing a prescribed process to be divided and executed, the acquisition unit acquiring, from the device apparatus, a remaining number of times needed before completion of the prescribed process, after a division process of the device apparatus based on the first command is completed. The transmission unit repeatedly executes transmission of the first command the remaining number of times.

In the first aspect of the present technique, the first command for causing the prescribed process to be divided and executed is transmitted to the device apparatus, and after the division process of the device apparatus based on the first command is completed, the remaining number of times needed before completion of the prescribed process is acquired from the device apparatus. Furthermore, transmission of the first command is repeatedly executed the remaining number of times.

A device apparatus according to a second aspect of the present technique includes an acquisition unit acquiring, from a device control apparatus, a first command for causing a prescribed process to be divided and executed, and a transmission unit transmitting, to the device control apparatus, a remaining number of times needed before completion of the prescribed process, after a division process based on the first command is completed. The acquisition unit repeatedly acquires the first command the remaining number of times.

A control method according to the second aspect of the present technique includes an acquisition unit of a device apparatus acquiring a first command from a device control apparatus, the device apparatus being controlled by the device control apparatus, the first command causing a prescribed process to be divided and executed, and a transmission unit of the device apparatus transmitting, to the device control apparatus a remaining number of times needed before completion of the prescribed process, after a division process based on the first command is completed. The acquisition unit repeatedly acquires the first command the remaining number of times.

A program according to a second aspect of the present technique causes a computer to function as an acquisition unit and a transmission unit. The acquisition unit causes a first command to be acquired from a device control apparatus, the first command causing a prescribed process to be divided and executed. The transmission unit causes a remaining number of times to be transmitted to the device control apparatus after a division process based on the first command is completed, the remaining number of times being needed before completion of the prescribed process. The acquisition unit repeatedly acquires the first command the remaining number of times.

In the second aspect of the present technique, the first command for causing the prescribed process to be divided and executed is acquired from the device control apparatus, and after the division process based on the first command is completed, the remaining number of times needed before completion of the prescribed process is transmitted to the device control apparatus. Furthermore, the first command is repeatedly acquired the remaining number of times.

A device control system according to a third aspect of the present technique includes a device apparatus and a device control apparatus. The device control apparatus includes a first transmission unit transmitting, to the device apparatus, a first command for causing a prescribed process to be divided and executed, and a first acquisition unit acquiring, from the device apparatus, a remaining number of times needed before completion of the prescribed process, after a division process of the device apparatus based on the first command is completed. The device apparatus includes a second acquisition unit acquiring the first command from the device control apparatus, and a second transmission unit transmitting, to the device control apparatus, the remaining number of times to the device control apparatus, after the division process based on the first command is completed. The first transmission unit repeatedly executes transmission of the first command the remaining number of times.

In the third aspect of the present technique, the first command for causing the prescribed process to be divided and executed is transmitted from the device control apparatus to the device apparatus and is acquired. After the division process of the device apparatus based on the first command is completed, the remaining number of times needed before completion of the prescribed process is transmitted from the device apparatus to the device control apparatus. Furthermore, transmission of the first command is repeatedly executed the remaining number of times.

The program can be provided by being transmitted via a transmission medium or being recorded in a recording medium.

The device control apparatus and the device apparatus may be independent apparatuses or internal blocks included in one apparatus.

### Advantageous Effect of Invention

According to the first to third aspects of the present technique, a process can be executed that needs a processing time longer than a processing time permitted for one command.

The effects described herein are not necessarily limited but may be any of the effects described in the present disclosure.

### BRIEF DESCRIPTION OF DRAWINGS

FIG. 1 is a block diagram illustrating an example of a configuration of an embodiment of a device control system to which the present technique is applied.

FIG. 2 is a diagram illustrating a constraint of a communication protocol.

FIG. 3 is a diagram illustrating a constraint of the communication protocol.

FIG. 4 is a flowchart illustrating a divided control process in an entire device control system.

FIG. 5 is a flowchart illustrating the divided control process on a host equipment side.

FIG. 6 is a flowchart illustrating the divided control process on a device apparatus side.

FIG. 7 is a flowchart illustrating a first modified example of the divided control process.

FIG. 8 is a flowchart illustrating a second modified example of the divided control process.

FIG. 9 is a block diagram illustrating an example of a configuration of an embodiment of a digital camera.

FIG. 10 is a block diagram illustrating an example of a hardware configuration of a memory card.

FIG. 11 is a diagram illustrating an FAT file system.

FIG. 12 is a diagram illustrating types of format commands.

FIG. 13 is a diagram illustrating a host-device process of a command “CMD49.”

FIG. 14 is a diagram illustrating an example of a field configuration of the command “CMD49.”

FIG. 15 is a diagram illustrating an example of data in an expansion register of the command “CMD49.”

FIG. 16 is a diagram illustrating a host-device process of a command “CMD48.”

FIG. 17 is a diagram illustrating an example of a field configuration of the command “CMD48.”

FIG. 18 is a diagram illustrating an example of data in an expansion register of the command “CMD48.”

FIG. 19 is a flowchart illustrating a divided control process using the commands “CMD48” and “CMD49.”

FIG. 20 is a block diagram illustrating an example of a configuration of an embodiment of a computer to which the present technique is applied.

### DESCRIPTION OF EMBODIMENTS

Forms in which the present technique is implemented (hereinafter referred to as embodiments) will be described below. The description is in the following order.
1. Example of Configuration of Device Control System
2. Flow of Divided Control Process of Entire Device Control System
3. Flow of Divided Control Process on Host Equipment Side
4. Divided control process Flow on Device Apparatus Side
5. First Modified Example of Divided Control Process
6. Second Modified Example of Divided Control Process
7. Example of Application to Digital Camera
8. Example of Computer Configuration

### <1. Example of Configuration of Device Control System>

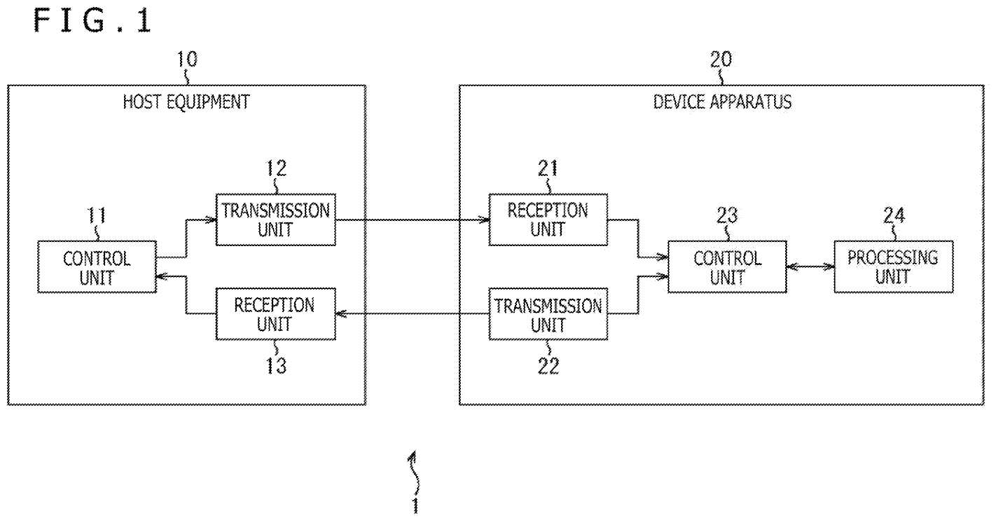

FIG. 1 is a block diagram illustrating an example of a configuration of an embodiment of a device control system to which the present technique is applied.

A device control system 1 in FIG. 1 includes host equipment 10 and a device apparatus 20.

The host equipment 10 includes, for example, a personal digital assistant, a desktop computer, a notebook computer, a cellular phone, an audio apparatus, a recording and reproducing apparatus, an imaging apparatus, and a home electric appliance.

The device apparatus 20 includes, for example, a semiconductor memory such as a flash memory, or a hard disk storage apparatus.

The host equipment 10 includes a device control apparatus controlling the device apparatus 20 to cause the device apparatus 20 to execute a prescribed operation (process). The host equipment 10 includes a control unit 11, a transmission unit 12, and a reception unit 13.

The control unit 11 controls the device apparatus 20 to, for example, determine an operation to be caused to be executed by the device apparatus 20. The transmission unit 12 transmits a prescribed command (control command) to the device apparatus 20 under the control of the control unit 11. The reception unit (acquisition unit) 13 receives (acquires) a command (reply command) transmitted from the device apparatus 20 and feeds the command to the control unit 11.

The device apparatus 20 executes a prescribed operation (process) under the control of the host equipment 10. The device apparatus 20 includes a reception unit 21, a transmission unit 22, a control unit 23, and a processing unit 24.

The reception unit (acquisition unit) 21 receives (acquires) a command (control command) transmitted from the host equipment 10, and feeds the command to the control unit 23. The transmission unit 22 transmits a command (reply command) to the host equipment 10 under the control of the control unit 23.

The control unit 23 causes the processing unit 24 to execute a prescribed process on the basis of a command transmitted from the host equipment 10 via the reception unit 21. The control unit 23 determines a command to be transmitted to the host equipment 10 according to a state, a result, or the like of processing by the processing unit 24, and instructs the transmission unit 22 to transmit the determined command. The processing unit 24 executes the prescribed process in accordance with the control of the control unit 23.

In the device control system 1 configured as described above, the host equipment 10 and the device apparatus 20 transmit and receive data including commands to and from each other in accordance with a prescribed communication protocol. Communication between the host equipment 10 and the device apparatus 20 may be either wired or wireless.

A communication protocol specifying transmission and reception of commands between the host equipment 10 and the device apparatus 20 pre-specifies a processing time provided on the device apparatus 20 side when one command is received.

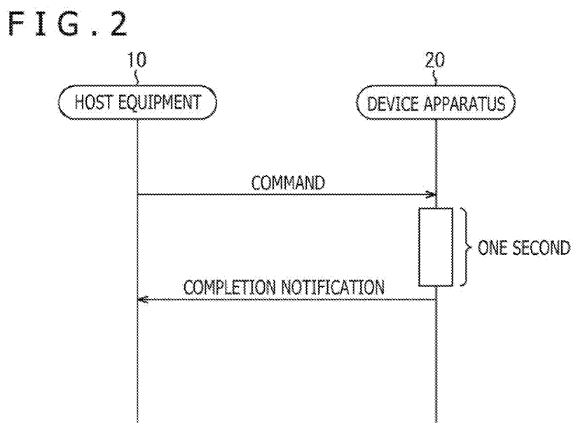

For example, in a case where the processing time provided on the device apparatus 20 side when one command is received is specified as one second, the device apparatus 20 needs to return a (command for) completion notification representing process completion, to the host equipment 10 within one second after the device apparatus 20 receives the command from the host equipment 10 as illustrated in FIG. 2.

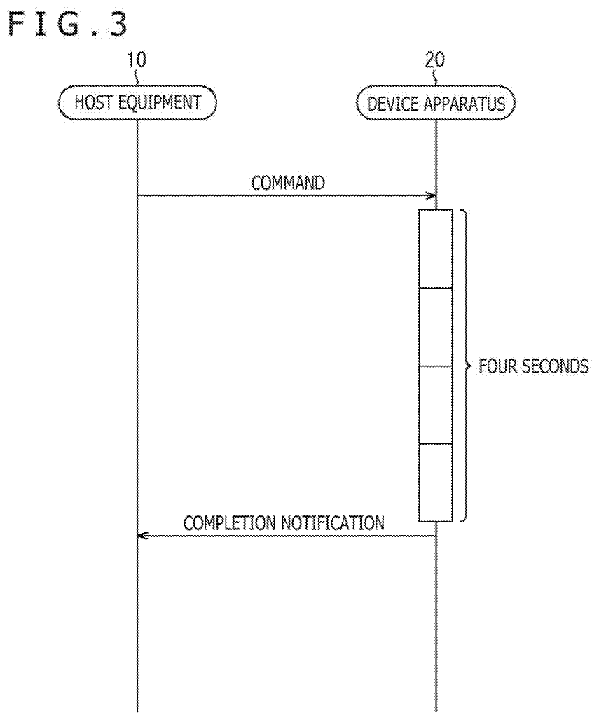

At this time, as illustrated in FIG. 3, a problem is posed in a case where an operation needing a processing time (four seconds in an example in FIG. 3) longer than the specified processing time (one second in the example in FIG. 2) is to be executed by the device apparatus 20. That is, in a case where the host equipment 10 continues to wait until the host equipment 10 is notified of processing completion, timeout occurs, precluding implementation of the process needing a processing time longer than the specified processing time.

Thus, the device control system 1 in FIG. 1 is configured to use a communication protocol pre-specifying a given time as a processing time for one command to implement a process (function) needing a processing time longer than the specified processing time for one command without changing the specified processing time.

The host equipment 10 causes the device apparatus 20 to divide the process needing a processing time longer than the specified processing time into a plurality of processes each needing the specified processing time or shorter and to separately execute the plurality of processes. The host equipment 10 can thus cause the device apparatus 20 to execute the process needing a processing time longer than the specified processing time.

### <2. Flow of Divided Control Process of Entire Device Control System>

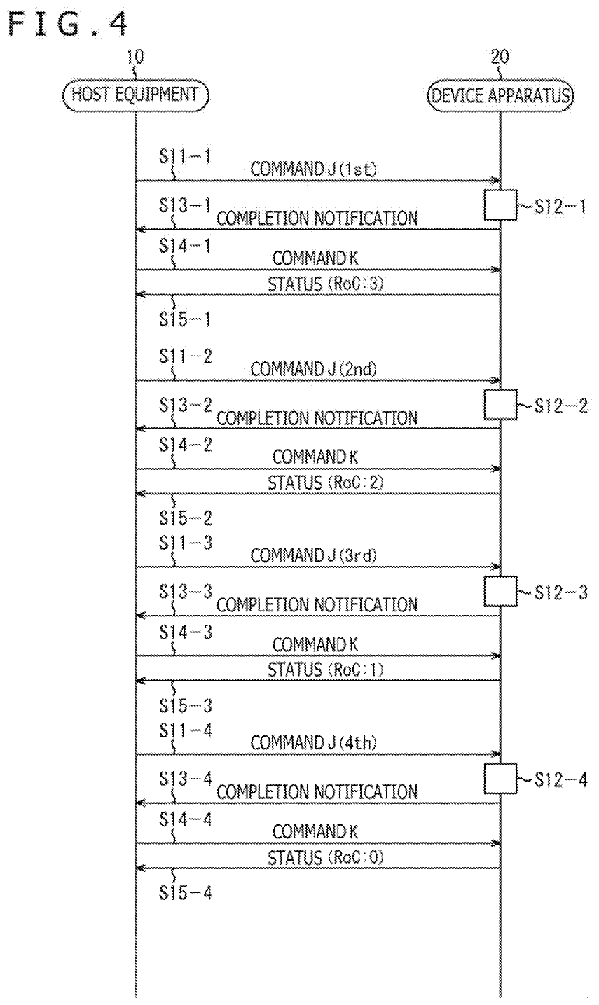

FIG. 4 is a flowchart illustrating a divided control process executed between the host equipment 10 and the device apparatus 20.

In FIG. 4, a process J represents the process needing a processing time longer than the specified processing time. As is the case with the examples in FIG. 2 and FIG. 3, the specified processing time is herein assumed to be one second, and the process J is herein assumed to need a processing time of four seconds. In this case, in a case where the process J is divided into processes each needing not longer than the specified processing time, assigned to regular commands, and the resultant processes are executed, a total of four divisional processes are needed.

The host equipment 10 causes the device apparatus 20 to execute a process from step S11 to step S15 described below a prescribed number of times (four times in this case).

In FIG. 4, a first divisional process from step S11 to step S15 is illustrated as a process in steps S11-1 to 15-1.

A second divisional process from step S11 to step S15 is illustrated as a process in steps S11-2 to 15-2.

A third divisional process from step S11 to step S15 is illustrated as a process in steps S11-3 to 15-3.

A fourth divisional process from step S11 to step S15 is illustrated as a process in steps S11-4 to 15-4.

Specifically, in step S11-1, the host equipment 10 transmits a command J to the device apparatus 20, the command J being a command for causing the process J to be executed.

In step S12-1, the device apparatus 20 receives the command J transmitted from the host equipment 10. The device apparatus 20 divides the process J into processes each needing not longer than the specified processing time, assigned to regular commands, and executes a part of the divided process within the specified processing time.

When the divisional process ends, in step S13-1, the device apparatus 20 transmits, to the host equipment 10, a (command for) completion notification representing processing completion, and the host equipment 10 receives the completion notification.

After receiving the completion notification, in step S14-1, the host equipment 10 transmits a command K to the device apparatus 20, the command K being a command for checking (requesting) a rest status (progress status) of the process J.

In step S15-1, as a reply to the received command K, the device apparatus 20 transmits, to the host equipment 10, a status including the remaining number of times of execution needed before completion of the process J (hereinafter referred to as the rest of count (RoC)), and the host equipment 10 receives the status.

Then, the host equipment 10 and the device apparatus 20 executes steps S11-2 to S15-2 corresponding to the second process from step S11 to step S15. In steps S11-2 to S15-2, the device apparatus 20 executes the second process of the four divisional processes, and the rest of count included in the status is “2.”

Then, the host equipment 10 and the device apparatus 20 execute steps S13-3 to S15-3 corresponding to the third process from step S11 to step S15. In steps S11-3 to S15-3, the device apparatus 20 executes the third process of the four divisional processes, and the rest of count included in the status is “1.”

Then, the host equipment 10 and the device apparatus 20 execute steps S13-4 to S15-4 corresponding to the fourth process from step S11 to step S15. In steps S11-4 to S15-4, the device apparatus 20 executes the fourth process of the four divisional processes, and the rest of count included in the status is “0.”

The host equipment 10 confirms that the rest of count included in the status received in step S15-4 is “0,” and ends the process.

As described above, the host equipment 10 repeats transmission, to the device apparatus 20, of the command J for instructing execution of the process J and transmission, to the device apparatus 20, of the command K checking the status including the rest of count.

### <3. Flow of Divided Control Process on Host Equipment Side>

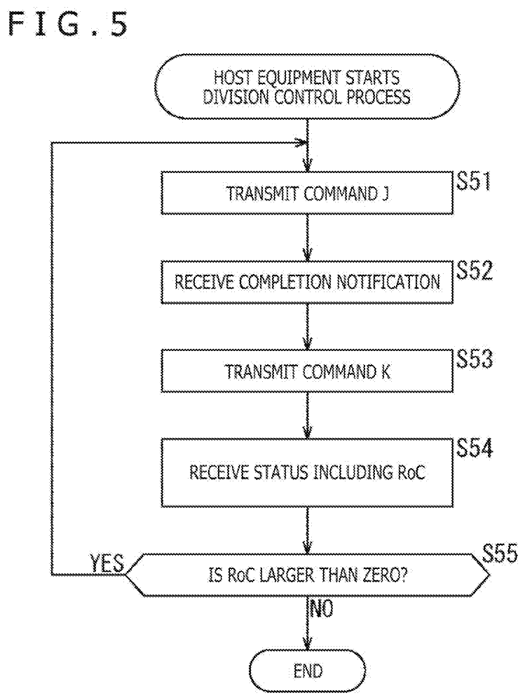

FIG. 5 is a flowchart of a divided control process of causing the command J to be executed in a case where the host equipment 10 is viewed independently.

First, in step S51, the host equipment 10 transmits, to the device apparatus 20, the command J for causing the process J to be executed.

In step S52, the host equipment 10 receives, from the device apparatus 20, the (command for the) completion notification representing process completion for the command J.

After receiving the completion notification, in step S53, the host equipment 10 transmits, to the device apparatus 20, the command K checking the rest status (progress status) of the process J.

In step S54, as a reply to the command K, the host equipment 10 receives, from the device apparatus 20, the status including the rest of count needed before the process J is completed.

In step S55, the host equipment 10 determines whether the rest of count included in the received status is larger than zero.

In a case of determining in step S55 that the rest of count is larger than zero, the host equipment 10 returns the process to step S51 to repeat the above-described process from step S51 to step S55.

On the other hand, in a case of determining that the rest of count is smaller than or equal to zero, that is, the rest of count is zero, the host equipment 10 ends the process.

### <4. Flow of Divided Control Process on Device Apparatus Side>

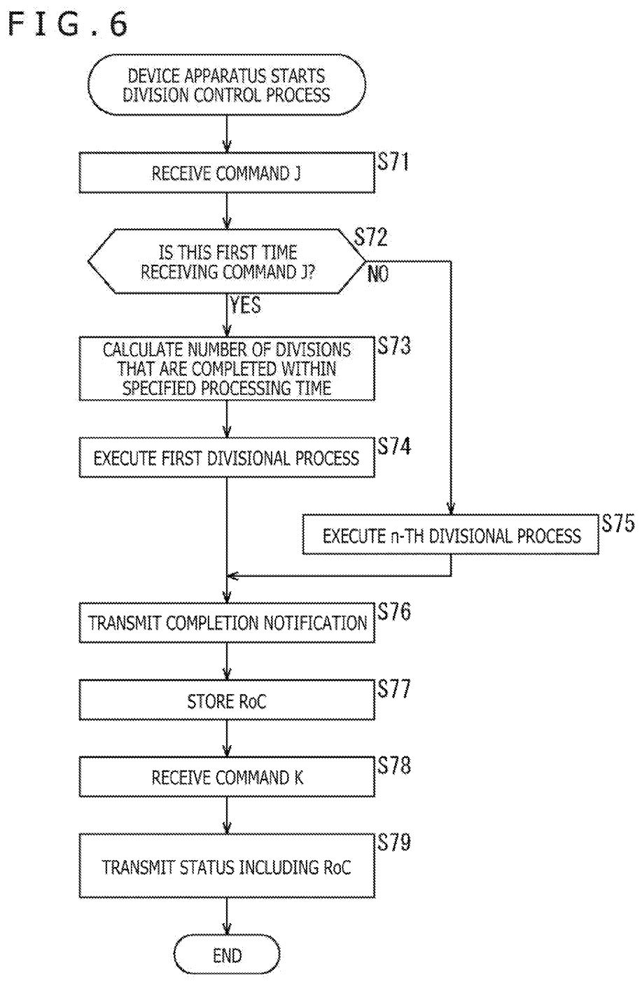

FIG. 6 is a flowchart of a divided control process of causing the command J to be executed in a case where the device apparatus 20 is viewed independently.

First, in step S71, the device apparatus 20 receives the command J for causing the process J to be executed, the command J having been transmitted from the host equipment 10.

In step S72, the device apparatus 20 determines whether the command J was received for the first time. In step S72, for example, in a case where the rest of count in step S77 described below is not stored in the internal memory, the command J is determined to have been received for the first time.

In step S72, in a case where it is determined that receiving the command J is the first time, the process proceeds to step S73. The device apparatus 20 calculates the number of divisions into which the process J has been divided to set a processing time for each division less than or equal to the specified processing time, and in step S74, executes the first divisional process.

On the other hand, in a case where it is determined that receiving the command J is not the first time, in other words, receiving the command J is the second or subsequent time, the process proceeds to step S75, and the device apparatus 20 executes the n-th (n>1) divisional process.

When the divisional processes are ended, in step S76, the device apparatus 20 transmits, to the host equipment 10, the (command for the) completion notification representing process completion. In step S77, the device apparatus 20 stores, in the internal memory, a value equal to the rest of count decremented by one.

In step S78, the device apparatus 20 receives the command K for checking the rest status (progress status) of the process J, the command K having been transmitted from the host equipment 10.

In step S78, as a reply to the command K, the device apparatus 20 transmits, to the host equipment 10, a status including the rest of count stored in the internal memory, and ends the process.

As described above, the host equipment 10 and the device apparatus 20 divides the process J needing a processing time longer than or equal to the specified processing time, into processes each needing a processing time less than or equal to the specified processing time assigned to a regular command, and executes the resultant processes a needed number of times. This allows execution of a process needing a processing time longer than or equal to the specified processing time.

The process based on the command J repeatedly executed the needed number of times is executed within the same specified processing time as that for the regular command. This prevents possible timeout. Furthermore, between the commands, any other command can be transmitted or received and executed.

However, in a case where the device apparatus 20 receives any other command during the divided process needing n divisional processes, the rest of count stored in the internal memory is temporarily reset. Thus, execution of the command is started all over again.

### <5. First Modified Example of Divided Control Process>

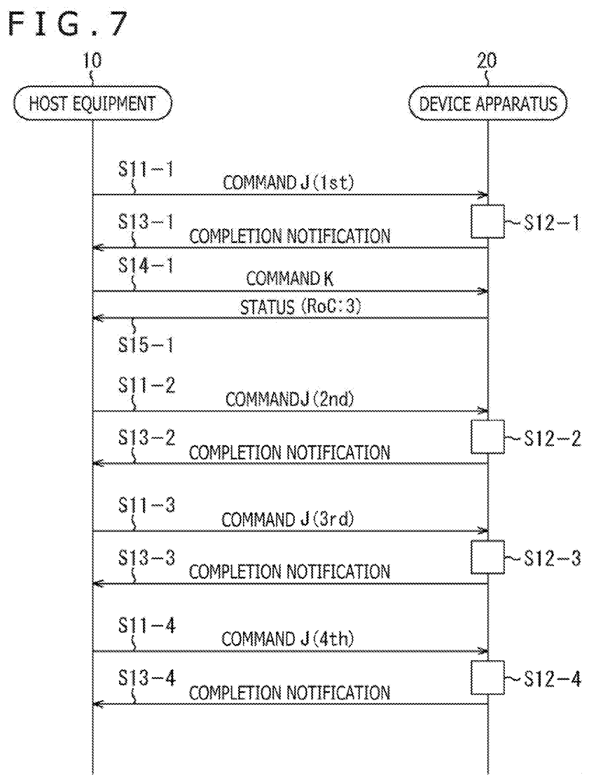

FIG. 7 is a flowchart illustrating a first modified example of the divided control process illustrated in FIG. 4.

The first communication process described with reference to FIG. 4 repeats, the prescribed number of times, both the command J for instructing execution of the process J and the command K for checking the status including the rest of count of the divisional processes.

However, the host equipment 10 can determine, by receiving the status except in an unusual case such as occurrence of an error, in response to the first command K, the number of times the command J needs to be executed.

Thus, as illustrated in FIG. 7, the host equipment 10, after receiving the completion notification in response to the first command J, transmits the command K and acquires the status as a reply to the command K. However, after receiving the completion notification in response to the second or subsequent command J, the host equipment 10 may avoid transmitting the command K to the device apparatus 20.

Compared to the divided control process in FIG. 4, in the first modified example in FIG. 7 the second and subsequent processes in steps S14 and S15 are omitted, in other words, the second and subsequent transmissions and receptions of the command K and transmissions and receptions of the status corresponding to a reply to the command K are omitted.

After reception of the completion notification in response to the first command J and further after reception of a completion notification assuming completion of the entire process J, that is, after the process in step S13-4 in FIG. 7, the command K and the status, returned in response to the command K, may be additionally transmitted and received to confirm that the rest of count of the divisional processes is zero.

Furthermore, transmission and reception of the command K and the status in steps S14 and S15 may be executed after reception of the completion notification for the command J and once every plurality of receptions of the completion notification.

### <6. Second Modified Example of Divided Control Process>

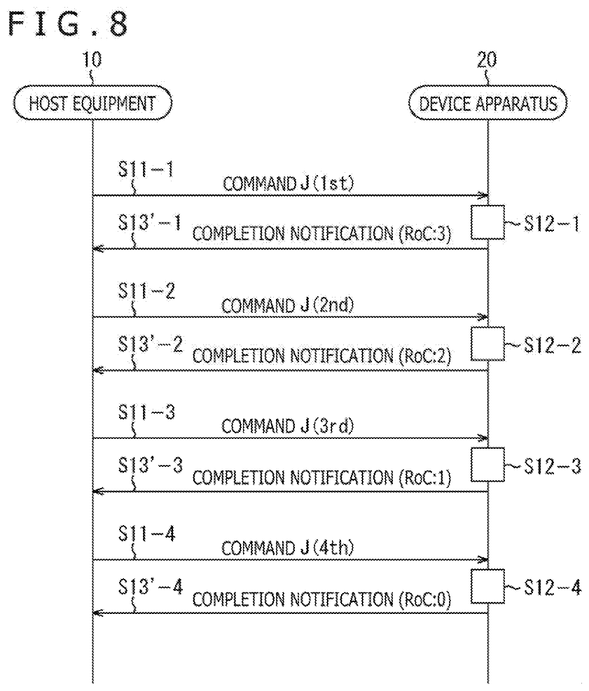

FIG. 8 is a flowchart illustrating a second modified example of the divided control process illustrated in FIG. 4.

The divided control process described with reference to FIG. 4 repeats, the prescribed number of times, both the command J for commanding execution of the process J and the command K for checking the status including the rest of count of the processes.

In the second modified example in FIG. 8, the rest of count needed before the process J is completed is included in the completion notification transmitted from the device apparatus 20 to the host equipment 10 in step S13 in the divided control process in FIG. 4, and the completion notification is transmitted. Thus, in the second modified example, transmission and reception of the command K and the status in steps S14 and S15 are omitted.

Specifically, in step S11-1, the host equipment 10 transmits a command J to the device apparatus 20, the command J causing the device apparatus 20 to execute the process J.

In step S12-1, the device apparatus 20 receives the command J transmitted from the host equipment 10 and executes, within the specified processing time, the first divisional process resulting from division of the process J.

In step S13′-1, the device apparatus 20 transmits, to the host equipment 10, the (command for the) completion notification representing process completion and including, as a parameter, the rest of count needed before the process J is completed. The host equipment 10 receives the completion notification.

A similar process is subsequently repeated until the rest of count included in the completion notification is zero.

As described above, the divided control process of the present technique allows execution, in an environment where regular commands may be executed, of a process needing a processing time longer than the processing time permitted for one command without causing timeout. Furthermore, between the commands, any other command can be accepted and executed.

### <7. Example of Application to Digital Camera>

An example will now be described in which the above-described control of the device control system 1 is applied to a specific apparatus.

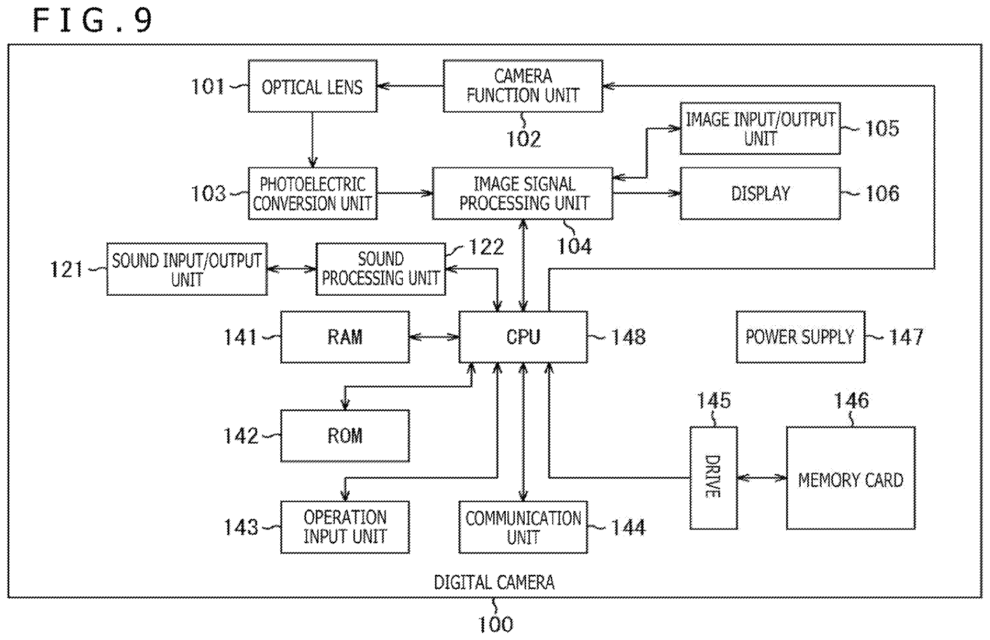

FIG. 9 is a block diagram illustrating an example of a configuration of an embodiment of a digital camera (digital still camera) to which the present technique is applied.

This digital camera 100 records data of a taken image (or sound) in a memory card 146 including, for example, an SD card and reproduces the data of the image (or sound) recorded in the memory card 146.

In FIG. 9, on the basis of the control of a camera function unit 102, the optical lens 101 collects light for an image of an object and causes the photoelectric conversion unit 103 to form the collected light into an image.

On the basis of a CPU (central processing unit) 148, the camera function unit 102 starts or ends an operation of taking an image of the object through an optical lens 101, and appropriately controls a zoom rate of the optical lens 101, the amount of light captured through the optical lens 101, and the like.

The photoelectric conversion unit 103 includes a photoelectric conversion element, for example, a CCD (charge-coupled device) or a CMOS (complementary metal oxide semiconductor) sensor. The photoelectric conversion unit 103 converts light fed from the optical lens 101 into an electric signal and feeds the light to an image signal processing unit 104.

The image signal processing unit 104 generates data of the image on the basis of a signal fed from the photoelectric conversion unit 103. For example, on the basis of the control of the CPU 148, the image signal processing unit 104 executes an A/D (Analog to Digital) conversion on an analog signal corresponding to the image of the object to obtain data of a digital image. The image signal processing unit 104 then applies image processing, for example, adjustment of white balance and interpolation of a defective image, to the data of the image. Furthermore, on the basis of the control of the CPU 148, the image signal processing unit 104 executes compression coding on the data of the image using an MEPG (Motion Picture Experts Group) scheme, a JPEG (Joint Photographic Expert Group) scheme, or the like, and decodes the data of the image subjected to the compression coding.

Furthermore, the image signal processing unit 104 feeds, to a display 106 and an image input/output unit 105, the data of the image resulting from adjustment of white balance or interpolation of a defective image executed on the signal resulting from the A/D conversion of the analog signal corresponding to the image of the object. More specifically, the image signal processing unit 104 converts the image data into, for example, a Red, Green, Blue (RGB) signal corresponding to an input scheme of the display 106, and feeds the RGB signal to the display 106. The image signal processing unit 104 similarly feeds the RGB signal to the image input/output unit 105.

The image input/output unit 105, for example, feeds an image signal supplied from an external apparatus, to the image signal processing unit 104, and also outputs, to the external apparatus, a signal corresponding to the data of the image output from the image signal processing unit 104. The display 106 includes, for example, an LCD (Liquid Crystal Display), to display an image based on the signal corresponding to the data of the image output from the image signal processing unit 104.

A sound input/output unit 121, for example, feeds, to a sound processing unit 122, a sound signal for sound collected by a microphone or the like, and also outputs, to a speaker or the like, sound corresponding to data of sound output from the sound processing unit 122. On the basis of the control of the CPU 148, the sound processing unit 122 generates compression-coded sound data on the basis of the sound signal fed from the sound input/output unit 121, and decodes the compression-coded sound data.

A RAM (Random Access Memory) 141 stores, for example, data such as programs read from the memory card 146 mounted in a drive 145 or data resulting from processing executed by the programs, and feeds the data to the CPU 148 as needed. The ROM 142 feeds pre-stored data to the CPU 148 as needed.

An operation input unit 143 includes, for example, operation keys or buttons and outputs, to the CPU 148, a signal corresponding to an operation input by a user.

A communication unit 144 includes, for example, a network card, and functions as an interface for wired communication such as Ethernet (registered trademark) and USB (Universal Serial Bus) or as an interface for wireless communication such as IEEE802.11a/b/g, and Bluetooth (registered trademark). On the basis of the control of the CPU 148, the communication unit 144 communicates with other apparatuses connected to a network on the basis of the control of the CPU 148.

The memory card 146, for example, an SD card, is mounted in the drive 145. The drive 145 accesses the mounted memory card 146 to record data in the memory card 146 or read recorded data from the memory card 146.

A power supply 147 supplies power needed to drive the digital camera 100.

The CPU 148 executes various calculations to process data, and controls operation of the digital camera 100 as a whole.

In the digital camera 100 is configured as described above, the digital camera 100 is used as the host equipment 10 in FIG. 1, and the memory card 146 is used as the device apparatus 20 in FIG. 1. The digital camera 100 and the memory card 146 can be caused to execute the above-described divided control process.

### <Example of Hardware Configuration of Memory Card>

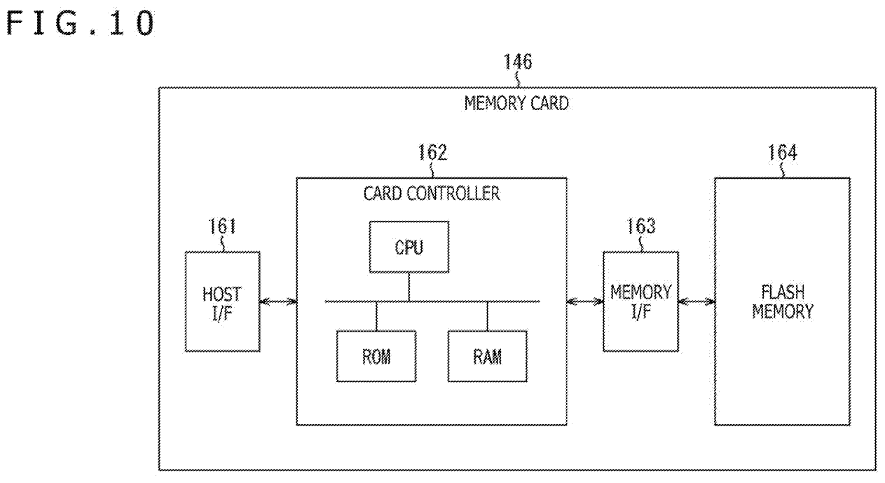

FIG. 10 is a block diagram illustrating an example of a hardware configuration of the memory card 146, used as the device apparatus 20.

The memory card 146 includes a host I/F 161, a card controller 162, a memory I/F 163, and a flash memory 164.

The host I/F 161 executes an interface process between the card controller 162 and the host equipment (digital camera 100).

The card controller 162 includes, for example, a CPU (Central Processing Unit), a ROM (Read Only Memory), and a RAM (Random Access Memory) to control operation of the memory card 146 as a whole. The CPU loads, onto the RAM, a control program stored in the ROM to write data to the flash memory 164 and read data from the flash memory 164 on the basis of instructions from the host equipment. Registers (including an expansion register described below) temporarily holding acquired data are formed in the RAM.

The memory I/F 163 executes an interface process between the card controller 162 and the flash memory 164.

Prescribed data is recorded in the flash memory 164. The flash memory 164 is a type of EEPROM (Electrically Erasable Programmable ROM) including a nonvolatile memory from which data can be electrically partially erased and which allows the data to be electrically rewritten. The flash memory 164 includes, for example, a NAND flash memory.

An example of a formatting process will be described below as a function (process) needing a processing time longer than the specified processing time; the digital camera 100, used as the host equipment 10, causes the memory card 146, used as the device apparatus 20, to execute this function.

Furthermore, in a case described below, the memory card 146 is an SD card.

Data is recorded and managed in the memory card 146 by an FAT file system.

### <FAT File System>

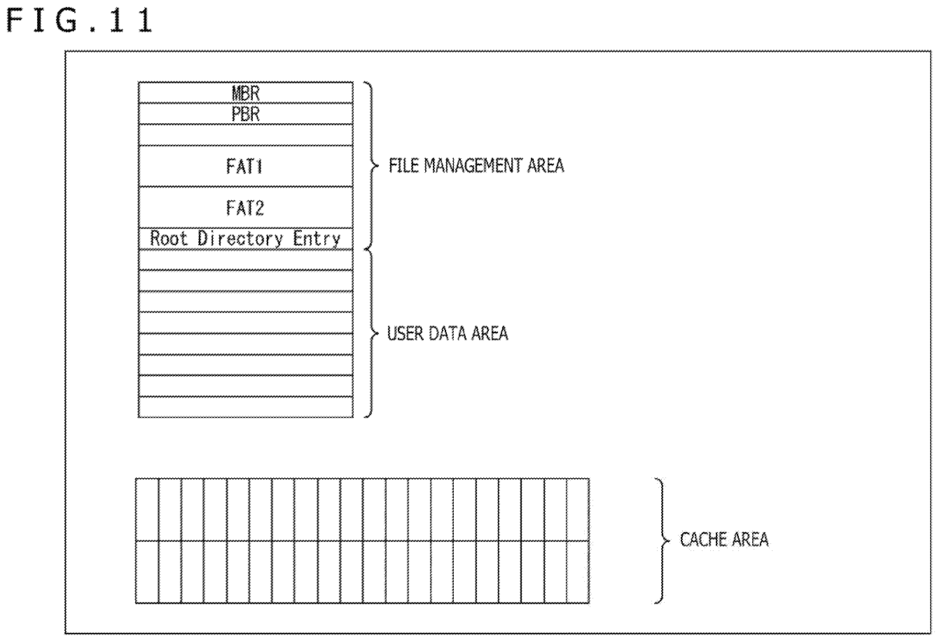

FIG. 11 illustrates a recording area of the memory card 146 managed by the FAT file system.

The recording area of the memory card 146 managed by the FAT file system is divided into a file management area, a user data area, and a cache area. The file management area and the user data area are formed, for example, in the flash memory 164. The cache area is formed, for example, in the RAM in the card controller 162.

An MBR (Master Boot Record) is arranged in a start sector with LBA (Logical Block Addressing)=0 in the file management area. The MBR includes information such as a boot code, a start sector and an end sector of each partition, and the size of each partition.

Furthermore, following the MBR, a PBR (Partition Boot Record), a FAT (File Allocation Table) 1, FAT2, and a root direct entry are recorded in the file management area.

The PBR is information including the number of clusters in the memory card 146 and boot codes for the partitions, and is loaded into the memory, for example, when an operating system is booted.

The FAT1 and the FAT2 are each a table with chain information about the clusters included in a file. The FAT1 and the FAT2 are referenced by the file system when the file system reads or write data from or to the file. Recorded contents of the FAT1 are typically similar to recorded contents of the FAT2 (the FAT1 and the FAT2 are each assumed to be a copy of the same table)

In the root directory entry, a directory entry corresponding to a file recorded in a root directory of the memory card 146 is stored. For example, in a case where a plurality of files are recorded in the root directory of the memory card 146, directory entries including information related to the individual files are formed in the root directory entry in association with the respective files. The information stored in each of the directory entries includes the name of the corresponding file, the date of creation of the file, the size of the file, and the start cluster number of the file.

In the user data area following the root directory entry, real data such as image data is recorded in clusters. One file typically includes a plurality of clusters, and chain information about the plurality of clusters included in the file is recorded in the above-described FAT1 or FAT2. That is, in the FAT1 or the FAT2, information like the following is recorded: “for a plurality of clusters present in the partition, how many clusters are present before the start cluster of a file, how many clusters are present before the next cluster, . . . , how many clusters are present before the final cluster of the file.”

### <Format Command Types>

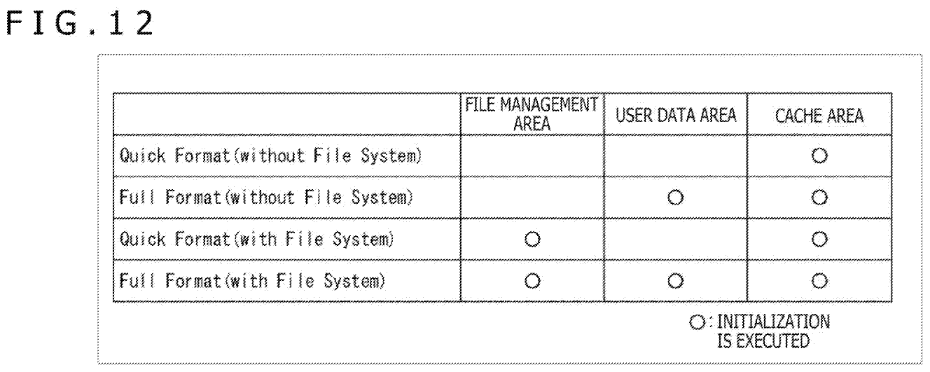

FIG. 12 is a table illustrating format command types used in a case where the CPU 148 of the digital camera 100 formats the memory card 146.

The CPU 148 can execute four format types: “Quick Format (Without File System),” “Full Format (Without File System),” “Quick Format (With File System),” and “Full Format (With File System).”

The format command “Quick Format (Without File System)” causes the CPU 148 to initialize only the cache area of the memory card 146.

The format command “Full Format (Without File System)” causes the CPU 148 to initialize the user data area and the cache area of the memory card 146.

The format command “Quick Format (With File System)” causes the CPU 148 to initialize the file management area and the cache area of the memory card 146.

The format command “Full Format (With File System)” causes the CPU 148 to initialize the file management area, the user data area, and the cache area of the memory card 146.

In a case where the memory card 146 is an SD card, a formatting process utilizing the above-described divided control process can be implemented using commands for extended functions “CMD48” and “CMD49” specified in “SD Specifications Part1 Physical Layer Simplified Specification Version 5.00 (Aut. 10, 2016).”

The commands “CMD48” and “CMD49” cause the host equipment to read and write data via the expansion register formed on the RAM of the SD card. The command “CMD48” causes the host equipment to read data from the SD card. The command “CMD49” causes the host equipment to write data to the SD card.

### <Description of Command “CMD49”

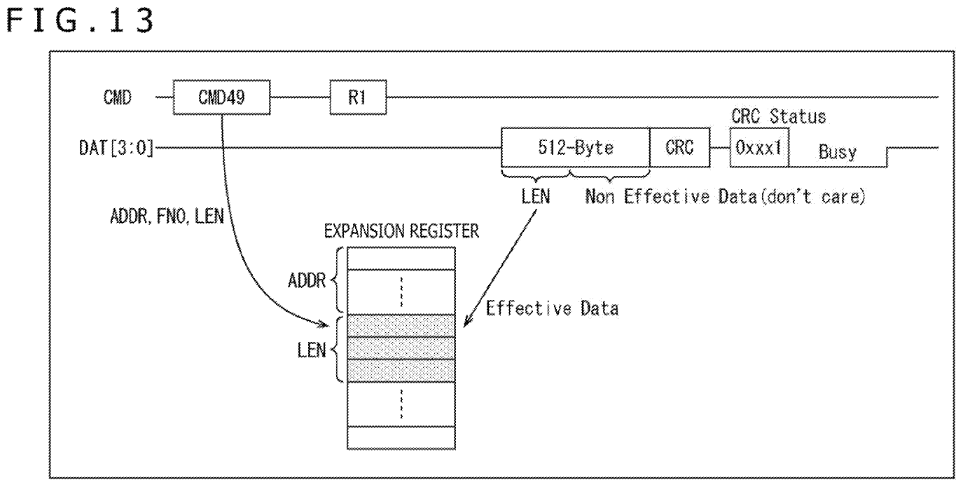

First, with reference to FIGS. 13 to 15, the “command 49” will be described that is used by the (CPU 148 of the) digital camera 100, used as the host equipment 10, to command execution of a formatting process.

FIG. 13 is a diagram illustrating a host-device process using the command “CMD49.”

The (CPU 148 of the) digital camera 100 sets prescribed data in a 512-byte data block in the expansion register, and transmits the command “CMD49” to the memory card 146. The memory card 146 receives the command “CMD49” and returns a response “R1” to the digital camera 100. The memory card 146 then reads the 512-byte data block from the expansion register.

The memory card 146 returns, to the digital camera 100, a CRC status indicating whether or not the 512-byte data block has been correctly received. The memory card 146 is in a busy state while executing a process indicated in the command “CMD49.” A maximum time for the busy state is one second.

Parameters of the command “CMD49” include ADDR specifying a position in the expansion register (read position) where data (valid data) to be read by the memory card 146 is recorded and LEN specifying the data length of the data (valid data) to be read. Data in the expansion register located beyond the data length indicated by LEN is invalid.

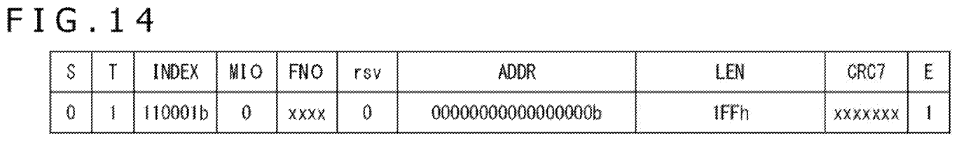

FIG. 14 illustrates an example of a field configuration of the command “CMD49.”

“S” denotes a start bit of the command, “T” denotes a bit indicating a transfer direction, and “INDEX” denotes a command number. “INDEX” of “110001b” is a binary number representing “49” (the last “b” represents binary).

“MIO” represents either a memory space or an I/O space. “MIO=0” represents the memory space.

“FNO” represents a number identifying an extended function and allows up to 16 extended functions to be specified. For example, in a case where the formatting function is assigned with number 1, “FNO=1” represents the formatting function.

“rsv” is a bit reserved for the future.

“ADDR” includes 17 bits to represent the read position in the expansion register.

“LEN” is indicative of a data length. A 9-bit “LEN” field is used to specify the data length of valid data in the expansion register that needs to be read. “1FFh” is a hexadecimal number representing 512 (the last “h” represents hexadecimal).

“CRC7” is indicative of a cyclic redundancy check code, and “E” is indicative of an end bit of the command.

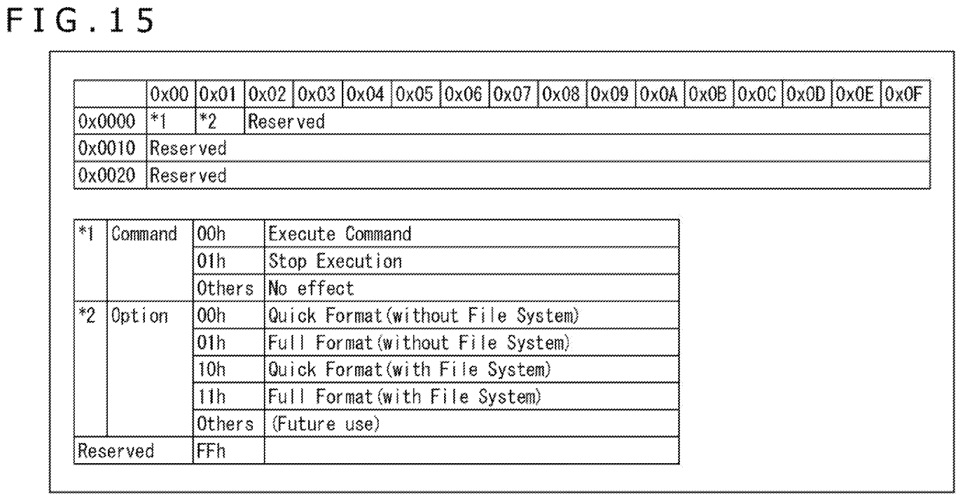

FIG. 15 illustrates an example of data described in the 512-byte data block in the expansion register, for a formatting process execution instruction using the command “CMD49.”

FIG. 15 illustrates only the first 48 bytes of the 512 bytes.

Information specifying whether to execute (“ooh”) or stop (“01h”) the formatting function identified by the FNO″ of the command “CMD49” is placed in the first 1 byte.

Information specifying the type of the format function identified by the FNO″ of the command “CMD49” is placed in the next 1 byte (the second byte). In this case, the information “00h” represents the format type “Quick Format (Without File System).” The information “01h” represents the format type “Full Format (Without File System).” The information “10h” represents the format type “Quick Format (With File System).” The information “11h” represents the format type “Full Format (With File System).”

The third and subsequent bytes are reserved for the future. Reserved bytes are represented as “FFh.”

The (CPU 148 of the) digital camera 100 transmits the above-described command “CMD49” to the memory card 146 and can thus command the memory card 146 to execute the formatting process.

### 5<Command “CMD48”

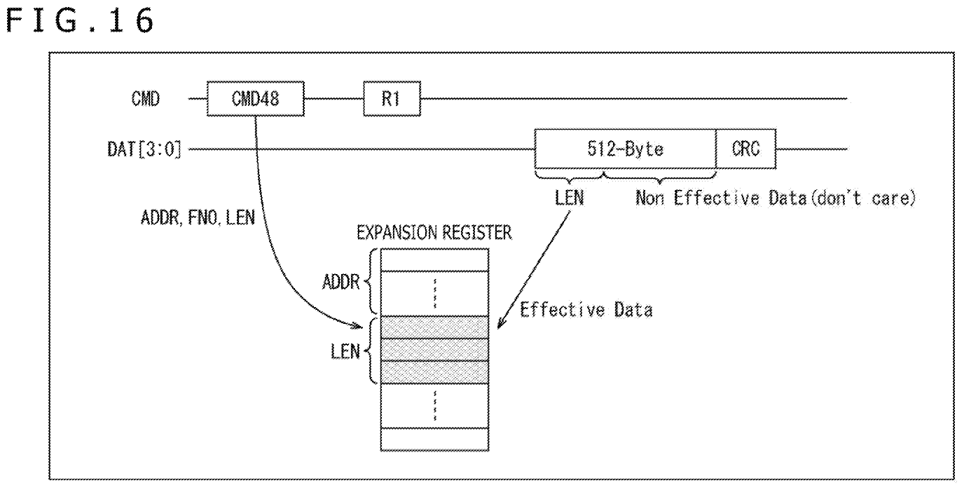

Now, with reference to FIGS. 16 to 18, the command “CMD48” used by the memory card 146, used as the device apparatus 20, to return an execution result (status) for the formatting process will be described.

FIG. 16 is a diagram illustrating a host-device process using the command “CMD48.”

The (CPU 148 of the) digital camera 100 transmits the command “CMD48” to the memory card 146. The memory card 146 receives the command “CMD48” and returns the response “R1” to the digital camera 100. The memory card 146 then writes prescribed data to the 512-byte data block in the expansion register.

The digital camera 100 reads the data written to the 512-byte data block in the expansion register.

Parameters of the command “CMD48” include ADDR specifying a position in the expansion register (write position) where data (valid data) to be written by the memory card 146 is recorded and LEN specifying the data length of the data (valid data) to be written. Data in the expansion register located beyond the data length indicated by LEN is invalid.

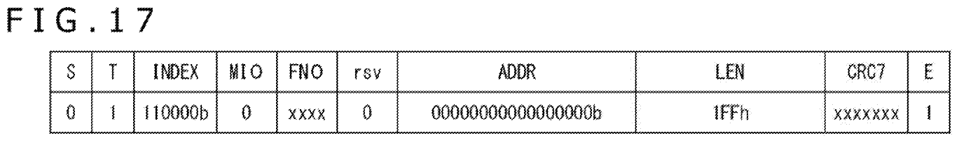

FIG. 17 illustrates an example of a field configuration of the command “CMD48.”

For “INDEX” representing a command number, “110000b” which is a binary number representing “48” (the last “b” represents binary) is set.

The other parameters are similar to the corresponding parameters of the command “CMD49” and will thus not be described below.

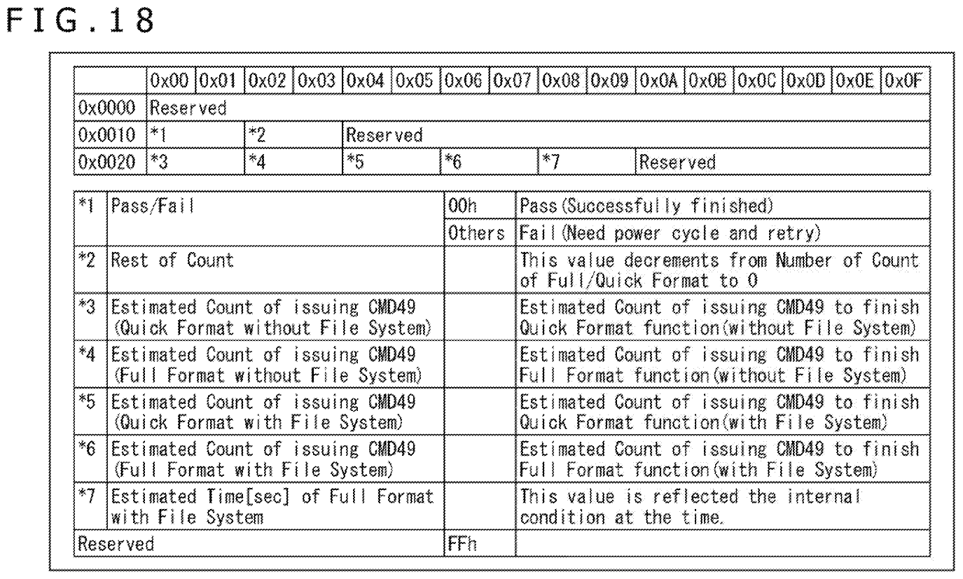

FIG. 18 illustrates an example of data described in the 512-byte data block in the expansion register by the memory card 146 having received the command “CMD48.”

FIG. 18 illustrates only the first 48 bytes of the 512 bytes.

The first 16 bytes are reserved for the future. Reserved bytes are represented as “FFh.”

Information indicating whether or not the formatting process has been successful is placed in the next two bytes (17th and 18th bytes). In this case, the information “00h” represents a success in the formatting process, and the information other than “00h” represents a failure in the formatting process.

The remaining number of times of execution (rest of count) needed before the formatting process is completed is placed in the next two bytes (19th and 20th bytes).

The next 12 bytes (21st to 32nd bytes) are reserved for the future.

An estimated number of issuances of the command “CMD49” involved in the formatting process with the format type “Quick Format (Without File System)” is placed in the next 2 bytes (33rd and 34th bytes).

An estimated number of issuances of the command “CMD49” involved in the formatting process with the format type “Full Format (Without File System)” is placed in the next 2 bytes (35th and 36th bytes).

An estimated number of issuances of the command “CMD49” involved in the formatting process with the format type “Quick Format (With File System)” is placed in the next 2 bytes (37th and 38th bytes).

An estimated number of issuances of the command “CMD49” involved in the formatting process with the format type “Full Format (With File System)” is placed in the next 2 bytes (39th and 40th bytes).

An estimated execution time needed to execute the formatting process with the format type “Full Format (With File System)” is placed in the next 2 bytes (41st and 42nd bytes).

The 43rd and subsequent bytes are reserved for the future.

As described above, the (CPU 148 of the) digital camera 100 transmits the command “CMD48” to the memory card 146 and can thus acquire an execution result for the formatting process, the rest of count, and the like from the memory card 146.

### 21 Divided Control Process Using Commands “CMD48” and “CMD49”

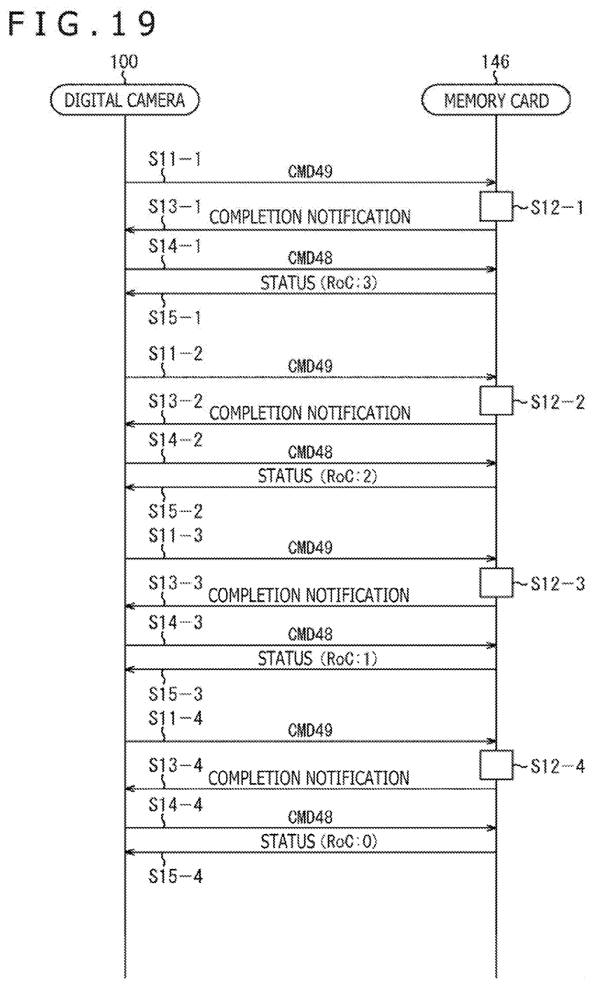

FIG. 19 illustrates that the formatting process between the digital camera 100 and the memory card 146 using the above-described commands “CMD48” and “CMD49” is associated with the divided control process illustrated in FIG. 4.

In step S11, the digital camera 100 sets execution of the formatting process (first byte) and the format type (second byte) in the 512-byte data block of the expansion register, and transmits, to the memory card 146, the command “CMD49” including “FNO” indicating the format function.

In step S12, the memory card 146 receives the command “CMD49” transmitted from the digital camera 100 and references the expansion register. The memory card 146 then executes a part of the formatting process within a processing time of up to one second.

The memory card 146 issues the busy state while executing the formatting process. The digital camera 100 recognizes the end of the busy state as the completion notification in step S13.

After the busy state is ended, in step S14, the digital camera 100 transmits, to the memory card 146, the command “CMD48” including “FNO” indicating the format function.

In step S15, for a reply to the command “CMD48,” the memory card 146 sets, in the 512-byte data block in the expansion register, the execution result for the formatting process (17th and 18th bytes), the rest of count before completion of the formatting process (19th and 20th bytes), and the like. The digital camera 100 reads the data from the expansion register.

The above-described process in steps S11 to S15 is repeated until the rest of count before completion of the formatting process is zero.

Since the commands “CMD48” and “CMD49” are commands for extended functions, whether or not the memory card 146 supports the extended functions may be unknown. In such a case, the digital camera 100 transmits a command “ACMD51” to the memory card 146 to check for a register indicating an SD configuration. This allows the digital camera 100 to check whether or not the extended functions are supported and then to start the above-described process. Alternatively, in a case where the command “CMD49” is transmitted without any check and an error or the like occurs, the digital camera 100 may determine that the extended functions are not supported to suspend the process.

Furthermore, the digital camera 100 may transmit the command “CMD48” before commanding execution of the formatting process using the command “CMD49,” to check the estimated number of times of execution of the formatting process and the estimated execution time, which are written to the 33rd to 42nd bytes in the expansion register. This allows the digital camera 100 to check for a difference in processing time according to the format type to determine which type of formatting is caused to be executed.

As described above, the divided control process of the present technique is applied to the operation control between the digital camera 100 and the memory card 146 to allow implementation of a formatting process needing a processing time of one second or more.

Furthermore, in a case where a new command is issued between repetitions of the command “CMD48” or “CMD49,” the memory card 146 can also normally accept the new command because each of the commands “CMD48” and “CMD49” is a regular command for which the corresponding process is executed within the processing time permitted for one command.

That is, the present technique allows execution of a process needing a processing time longer than the processing time permitted for one command while maintaining a state where an optional command can be accepted from the digital camera 100, used as the host equipment, and can be processed.

In the above-described embodiment, the example of the formatting process has been described as an example of a process needing a processing time longer than the processing time permitted for one command.

However, the present technique can, of course, be applied to processes other than the formatting process. For example, the present technique is applicable to a wear leveling process for leveling the number of times that the flash memory 164 in the memory card 146 is used, a defragmentation process for rearranging fragmented files, an autonomous testing process for the device, and the like.

### <8. Example of Computer Configuration>

The above-described series of processes can be executed by hardware or by software. In a case where the series of processes are executed by software, program included in the software is installed in a computer. Here, examples of the computer includes a microcomputer incorporated in dedicated hardware, and for example, a general-purpose personal computer capable of executing various functions when various programs are installed in the computer.

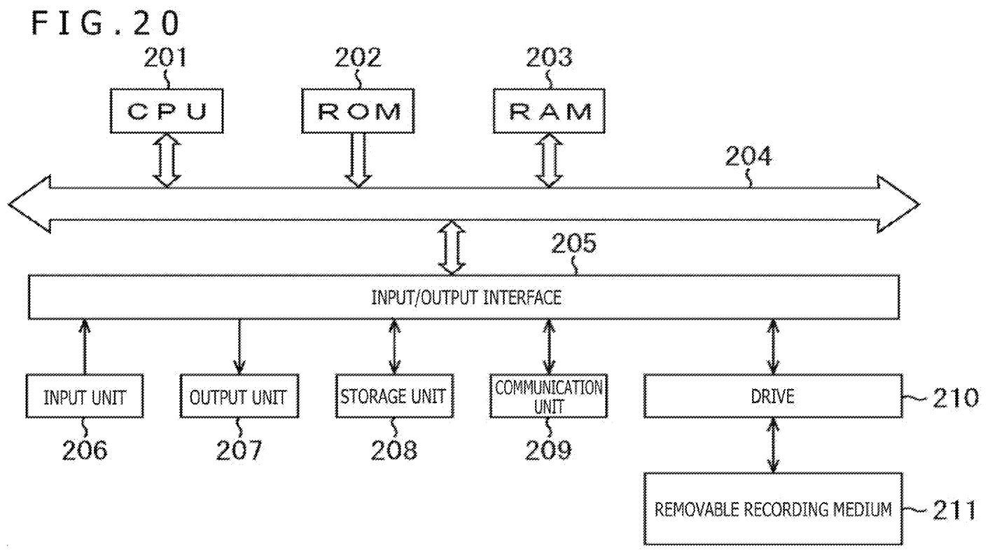

FIG. 20 is a block diagram illustrating an example of a hardware configuration of a computer used as the host equipment 10 or the device apparatus 20 to execute the above-described series of processes using programs.

In the computer, a CPU (Central Processing Unit) 201, a ROM (Read Only Memory) 202, and a RAM (Random Access Memory) 203 are connected together by a bus 204.

An input/output interface 205 is connected to the bus 204. An input unit 206, an output unit 207, a storage unit 208, a communication unit 209, and a drive 210 are connected to the input/output interface 205.

The input unit 206 includes a keyboard, a mouse, and a microphone. The output unit 207 includes a display and a speaker. The storage unit 208 includes a hard disk and a nonvolatile memory. The communication unit 209 includes a network interface. The drive 210 drives a removable recording medium 211 such as a magnetic disk, an optical disc, or a semiconductor memory.

In the computer configured as described above, the above-described series of processes are executed by the CPU 201 by loading the program stored in the storage unit 208, into the RAM 203 via the input/output interface 205 and the bus 204 for execution.

In the computer, the program can be installed in the storage unit 208 via the input/output interface 205 by mounting the removable recording medium 211 in the drive 210. Furthermore, the program can be received by the communication unit 209 via a wired or wireless transmission medium such as a local area network, Internet, or digital satellite broadcasting, and installed in the storage unit 108. Otherwise the program can be pre-installed in the ROM 202 or the storage unit 208.

The steps described in the flowcharts in the specification may of course be executed according to a time sequence in the above-described order and may not necessarily be executed according to the time sequence. The steps may be executed in parallel or at needed timings, for example, when the steps are invoked.

Furthermore, the system as used herein means a set of a plurality of components (apparatuses, modules (parts), or the like) regardless of whether or not all the components are located in the same housing. Therefore, a plurality of apparatuses housed in separate housings and connected together via a network and one apparatus including a plurality of modules housed in one housing are both systems.

The embodiments of the present technique is not limited to the above-described embodiments. Various changes can be made to the embodiments without departing from the scope of the present technique.

For example, embodiments formed by appropriately combining all or parts of the above-described embodiments can be adopted.

For example, the present technique can be configured in the form of cloud computing in which one function is shared and jointly processed by a plurality of apparatuses via a network.

Furthermore, the steps described above with reference to the flowcharts can be executed by one apparatus or shared and executed by a plurality of apparatuses.

Moreover, in a case where one step includes a plurality of processes, the plurality of processes included in the one step can be executed by one apparatus or shared and executed by a plurality of apparatuses.

The effects described herein are only illustrative and are not limitative, and effects other than those described herein may be produced by the present technique.

The present technique can also be configured as follows.

(1)

A device control apparatus including:

a transmission unit transmitting, to a device apparatus, a first command for causing a prescribed process to be divided and executed; and

an acquisition unit acquiring a remaining number of times needed before completion of the prescribed process, after a division process of the device apparatus based on the first command is completed, in which

the transmission unit repeatedly executes transmission of the first command the remaining number of times.

(2)

The device control apparatus according to the (1), in which

the acquisition unit acquires the remaining number of times from the device apparatus each time the transmission unit transmits the first command.

(3)

The device control apparatus according to the (1) or (2), in which

the acquisition unit acquires the remaining number of times from the device apparatus along with a notification of completion of the division process.

(4)

The device control apparatus according to the (1) or (2), in which

the transmission unit transmits, to the device apparatus, a second command requesting an execution result for the first command and the remaining number of times, and

the acquisition unit acquires, from the device apparatus, the execution result and the remaining number of times returned in accordance with the second command.

(5)

The device control apparatus according to the (4), in which

the device apparatus includes an SD card,

the first command is a command “CMD49,” and

the second command is a command “CMD48.”

(6)

A control method including:

a transmission unit of a device control apparatus transmitting a first command to a device apparatus, the device control apparatus controlling operation of the device apparatus, the first command causing a prescribed process to be divided and executed; and

an acquisition unit of the device control apparatus acquiring, from the device apparatus, a remaining number of times needed before completion of the prescribed process, after a division process of the device apparatus based on the first command is completed, in which

the transmission unit repeatedly executes transmission of the first command the remaining number of times.

(7)

A program for causing a computer to function as a transmission unit and an acquisition unit,

the transmission unit causing a first command to be transmitted to a device apparatus, the first command causing a prescribed process to be divided and executed, and

the acquisition unit acquiring, from the device apparatus, a remaining number of times needed before completion of the prescribed process, after a division process of the device apparatus based on the first command is completed, in which

the transmission unit repeatedly executes transmission of the first command the remaining number of times.

(8)

A device apparatus including:

an acquisition unit acquiring, from a device control apparatus, a first command for causing a prescribed process to be divided and executed; and

a transmission unit transmitting, to the device control apparatus, a remaining number of times needed before completion of the prescribed process, after a division process based on the first command is completed, in which

the acquisition unit repeatedly acquires the first command the remaining number of times.

(9)

The device apparatus according to the (8), in which

the transmission unit transmits the remaining number of times to the device control apparatus each time the acquisition unit acquires the first command.

(10)

The device apparatus according to the (8) or (9), in which

the transmission unit transmits the remaining number of times to the device control apparatus along with a notification of completion of the division process based on the first command.

(11)

The device apparatus according to the (8) or (9), in which

the acquisition unit acquires a second command requesting an execution result for the first command and the remaining number of times, and

the transmission unit transmits the execution result and the remaining number of times to the device control apparatus in accordance with the second command.

(12)

The device apparatus according to the (11), in which

the device apparatus is an SD card,

the first command is a command “CMD49,” and

the second command is a command “CMD48.”

(13)

A control method including:

an acquisition unit of a device apparatus acquiring a first command from a device control apparatus, the device apparatus being controlled by the device control apparatus, the first command causing a prescribed process to be divided and executed; and

a transmission unit of the device apparatus transmitting, to the device control apparatus, a remaining number of times needed before completion of the prescribed process, after a division process based on the first command is completed, in which

the acquisition unit repeatedly acquires the first command the remaining number of times.

(14)

A program for causing a computer to function as an acquisition unit and a transmission unit,

the acquisition unit causing a first command to be acquired from a device control apparatus, the first command causing a prescribed process to be divided and executed, and

the transmission unit causing a remaining number of times to be transmitted to the device control apparatus after a division process based on the first command is completed, the remaining number of times being needed before completion of the prescribed process, in which

the acquisition unit repeatedly acquires the first command the remaining number of times.

(15)

A device control system including a device apparatus and a device control apparatus,

the device control apparatus including:
a first transmission unit transmitting, to the device apparatus, a first command for causing a prescribed process to be divided and executed; and
a first acquisition unit acquiring, from the device apparatus, a remaining number of times needed before completion of the prescribed process, after a division process of the device apparatus based on the first command is completed,

the device apparatus including:
a second acquisition unit acquiring the first command from the device control apparatus; and
a second transmission unit transmitting the remaining number of times to the device control apparatus after the division process based on the first command is completed, in which

the first transmission unit repeatedly executes transmission of the first command the remaining number of times.

### REFERENCE SIGNS LIST

1 Device control system, 10 Host equipment, 11 Control unit, 12 Transmission unit, 13 Reception unit, 20 Device apparatus, 21 Reception unit, 22 Transmission unit, 23 Control unit, 24 Processing unit, 100 Digital camera, 148 CPU, 146 Memory card, 162 Card controller, 164 Flash memory, 201 CPU, 202 ROM, 203 RAM, 206 Input unit, 207 Output unit, 208 Storage unit, 209 Communication unit, 210 Drive, 211 Removable recording medium

1. A device control apparatus comprising:
a transmission unit transmitting, to a device apparatus, a first command for causing a prescribed process to be divided and executed; and
an acquisition unit acquiring a remaining number of times needed before completion of the prescribed process, after a division process of the device apparatus based on the first command is completed, wherein
the transmission unit repeatedly executes transmission of the first command the remaining number of times.

2. The device control apparatus according to claim 1, wherein
the acquisition unit acquires the remaining number of times from the device apparatus each time the transmission unit transmits the first command.

3. The device control apparatus according to claim 1, wherein
the acquisition unit acquires the remaining number of times from the device apparatus along with a notification of completion of the division process.

4. The device control apparatus according to claim 1, wherein
the transmission unit transmits, to the device apparatus, a second command requesting an execution result for the first command and the remaining number of times, and
the acquisition unit acquires, from the device apparatus, the execution result and the remaining number of times returned in accordance with the second command.

5. A control method comprising:
a transmission unit of a device control apparatus transmitting a first command to a device apparatus, the device control apparatus controlling operation of the device apparatus, the first command causing a prescribed process to be divided and executed; and
an acquisition unit of the device control apparatus acquiring, from the device apparatus, a remaining number of times needed before completion of the prescribed process, after a division process of the device apparatus based on the first command is completed, wherein
the transmission unit repeatedly executes transmission of the first command the remaining number of times.

6. A program for causing a computer to function as a transmission unit and an acquisition unit,
the transmission unit causing a first command to be transmitted to a device apparatus, the first command causing a prescribed process to be divided and executed, and
the acquisition unit acquiring, from the device apparatus, a remaining number of times needed before completion of the prescribed process, after a division process of the device apparatus based on the first command is completed, wherein
the transmission unit repeatedly executes transmission of the first command the remaining number of times.

7. A device apparatus comprising:
an acquisition unit acquiring, from a device control apparatus, a first command for causing a prescribed process to be divided and executed; and
a transmission unit transmitting, to the device control apparatus, a remaining number of times needed before completion of the prescribed process, after a division process based on the first command is completed, wherein
the acquisition unit repeatedly acquires the first command the remaining number of times.

8. The device apparatus according to claim 7, wherein
the transmission unit transmits the remaining number of times to the device control apparatus each time the acquisition unit acquires the first command.

9. The device apparatus according to claim 7, wherein
the transmission unit transmits the remaining number of times to the device control apparatus along with a notification of completion of the division process based on the first command.

10. The device apparatus according to claim 7, wherein
the acquisition unit acquires a second command requesting an execution result for the first command and the remaining number of times, and
the transmission unit transmits the execution result and the remaining number of times to the device control apparatus in accordance with the second command.

11. A control method comprising:
an acquisition unit of a device apparatus acquiring a first command from a device control apparatus, the device apparatus being controlled by the device control apparatus, the first command causing a prescribed process to be divided and executed; and
a transmission unit of the device apparatus transmitting, to the device control apparatus, a remaining number of times needed before completion of the prescribed process, after a division process based on the first command is completed, wherein
the acquisition unit repeatedly acquires the first command the remaining number of times.

12. A program for causing a computer to function as an acquisition unit and a transmission unit,
the acquisition unit causing a first command to be acquired from a device control apparatus, the first command causing a prescribed process to be divided and executed, and
the transmission unit causing a remaining number of times to be transmitted to the device control apparatus after a division process based on the first command is completed, the remaining number of times being needed before completion of the prescribed process, wherein
the acquisition unit repeatedly acquires the first command the remaining number of times.

13. A device control system comprising a device apparatus and a device control apparatus,
the device control apparatus comprising:
a first transmission unit transmitting, to the device apparatus, a first command for causing a prescribed process to be divided and executed; and
a first acquisition unit acquiring, from the device apparatus, a remaining number of times needed before completion of the prescribed process, after a division process of the device apparatus based on the first command is completed,
the device apparatus comprising:
a second acquisition unit acquiring the first command from the device control apparatus; and
a second transmission unit transmitting the remaining number of times to the device control apparatus, after the division process based on the first command is completed, wherein
the first transmission unit repeatedly executes transmission of the first command the remaining number of times.
